(19) United States
(12) Patent Application Publication
(10) Pub. No.: US 2025/0071867 A1
(43) Pub. Date: Feb. 27, 2025

(54) DEVICE AND METHOD FOR PERFORMING COOKING

(71) Applicant: ON2COOK INDIA PVT LTD, Gandhinagar, Gujarat (IN)

(72) Inventor: Sudhir Sanandan, Ahmedabad, Gujarat (IN)

(21) Appl. No.: 18/725,111

(22) PCT Filed: Jan. 9, 2023
(86) PCT No.: PCT/IB2023/050153

§ 371 Date: Jun. 27, 2024

(30) Foreign Application Priority Data
Jan. 7, 2022 (IN) 202221001012

(51) Int. Cl. H05B 6/64; A47J 27/086; A47J 27/088; A47J 27/09; A47J 37/06; A47J 37/12

(52) U.S. Cl. CPC H05B 6/647; A47J 27/086; A47J 27/088; A47J 27/09; A47J 37/0629; A47J 37/0647; A47J 37/128; A47J 37/129; H05B 6/6432

(57) ABSTRACT

A cooking pot for pressure cooking or frying is disclosed, comprising a housing 122 accommodating a pan 112 to hold food items to be cooked, and one or more heating devices to heat the pan. A lid 102 covers the top side of the housing 122 and creates an enclosure 124 above the pan 112. The one or more heating devices include a microwaves generating device 202 located remote from the airtight enclosure 124. A microwave guide 210 is provided to transfer microwaves generated by the remotely located microwaves generating device 202 to the pan 112. A window 110 is provided for passage of the microwaves to the pan 112, and includes a microwave transparent material, which can withstand pressure in the enclosure 124 when the cooking pot is configured for pressure cooking. A flame stove 204 is provided below the pan 112 for direct heating of the pan 112.

### TECHNICAL FIELD

The present disclosure relates to a cooking pot. In particular, the present disclosure relates to a cooking pot that allows heating using multiple sources of heat energy including microwaves, and may be configured for different types of cooking processes, such as pressure cooking and frying.

### BACKGROUND

Background description includes information that may be useful in understanding the present invention. It is not an admission that any of the information provided herein is prior art or relevant to the presently claimed invention, or that any publication specifically or implicitly referenced is prior art.

Cooking apparatuses that combine the benefits of both open flame/induction/convection/conduction and other modern microwave cooking into a single apparatus, i.e. allow multiple modes of cooking, are known in the art. For example, one such apparatus is disclosed in the applicant's earlier filed United States Patent application number US20150144006A1. However, such cooking apparatuses suffer from drawback that the microwave generating device is provided in a lid that pivotally moves to cover a cooking pan. Weight of the microwave generating device requires the pivotal support for the lid to be robust. Besides, the alignment of the lid with the pan is problematic and requires a mechanism to align the pan with the lid to ensure that the lid is properly closed over the pan before the microwave generating device is put on.

In addition to above drawbacks, the known cooking apparatuses that combine the benefits of both open flame/induction/convection/conduction and other modern microwave cooking do not provide the benefit of pressure cooking or frying. As is well known, pressure cooking is the process of cooking food under high pressure steam, employing water or a water-based cooking liquid, in a sealed vessel known as a pressure cooker. High pressure limits boiling, and permits cooking temperatures well above 100° C. for a faster cooking leading to a more efficient use of heat energy provided to the pressure cooker. It is also known to provide health benefits as pressure cooking is known to reduce certain toxins, such as aflatoxins in rice. It is reported that use of pressure cookers has declined during recent times, and the decline is partly attributed to competition from other fast cooking devices, such as microwave ovens. It would therefore be advantageous if a cooking apparatus could be provided that combines the benefits of microwave cooking with pressure cooking. On the other hand frying is an unavoidable process in certain kinds of food items, such as fast food items. Fast food outlets, such as McDonalds®, carry out frying of large numbers of fries and patties. Conventional method for frying the food items do not provide advantages of modern fast heating devices, such as microwave heating.

There is therefore need in the art for a cooking pot that overcomes drawbacks of known cooking apparatuses that allow heating using multiple sources of heat energy including microwaves, and can be configured for pressure cooking or frying.

### OBJECTS OF THE INVENTION

A general object of the present disclosure is to provide an improved cooking pot that overcomes drawbacks of known cooking apparatuses that use multiple sources of heat energy including microwaves.

An object of the present disclosure is to provide a cooking pot that can be configured for pressure cooking or frying.

Another object of the present disclosure is to provide a cooking pot that ensures proper alignment of a pan with lid of the cooking pot.

Another object of the present disclosure is to provide a cooking pot that does not allow a microwaves generating device to be switched on unless the lid is properly placed over the pan.

Yet another object of the present disclosure is to provide a cooking pot that ensures that the microwaves generating device is unaffected by pressure of a pressurized pan.

These and other objects of the present invention will become readily apparent from the following detailed description taken in conjunction with the accompanying drawings.

### SUMMARY

Aspects of the present disclosure relate to an improved cooking pot that uses multiple sources of heat energy including microwaves. In particular, the proposed cooking pot overcomes drawbacks of known cooking apparatuses that use multiple sources of heat energy including microwaves. More particularly, the disclosed cooking pot is based on a wave guide and may be configured for different types of cooking processes, such as pressure cooking and frying.

In an aspect, the disclosed cooking pot for cooking includes a housing that accommodates a pan that is accessible from a top side of the housing and is configured to hold food items to be cooked. The housing further accommodates one or more heating devices to heat the pan. A lid is configured such that in a closed position of the lid, it covers the top side of the housing and creates an enclosure above the pan to enable cooking of contents of the pan.

In an aspect, the one or more heating devices include a microwaves generating device located remote from the airtight enclosure. In another aspect, the cooking pan includes a microwave guide to transfer microwaves generated by the remotely located microwaves generating device to the enclosure.

The cooking pot may include a window located in the housing. The window can provide a passage for the microwaves from the microwave guide to the enclosure above the pan for the microwaves to heat the food items held in the pan.

In an embodiment, the lid is configured such that the enclosure created in the closed position of the lid is an air tight enclosure to enable pressure cooking of contents of the pan, and the window may include a microwave transparent material that is capable of withstanding pressure in the airtight enclosure during the pressure cooking.

In an alternate embodiment, pan may be configured to hold oil for frying the food items.

In an embodiment, the lid may be hinged to the housing for a pivotal movement between an open position and the closed position, and may include a lid lifting handle located on a front surface of the lid.

In an alternate embodiment, the lid may be a detachable lid configured to be totally removed from the housing in an open position of the lid, and may include a lid handle located on a top surface of the lid.

The lid may include a choke located around a circumference of the lid that engages with the housing when the lid is closed over the housing. The choke may be configured to prevent leakage of microwaves from the airtight enclosure.

The one or more heating devices may include at least one of a hot plate, an electric heating coil and a flame stove, wherein the at least one of a hot plate, an electric heating coil and a flame stove is located below the pan to provide a direct heating to the pan.

The cooking pot may include a sensing mechanism to sense proper closing of the lid to ensure that microwaves reaching the airtight enclosure do not leak out. The sensing mechanism include a plurality of retractable plungers, such as pogo pins, provided on inner side walls of the housing such that when the lid is closed, the plungers come in contact with the lid to detect if a gap between the lid and the side walls of the airtight enclosure is less than a predefined gap value.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIGS. 1A and 1B illustrate exemplary perspective views of a first embodiment of the proposed cooking pot configured for pressure cooking, respectively showing a hinged lid of the cooking pot in open and closed positions, in accordance with embodiments of the present disclosure.

FIG. 2A illustrates an exemplary perspective view of the cooking pot of FIGS. 1A and 1B, showing internal details of the cooking pot, in accordance with embodiments of the present disclosure.

FIG. 2B illustrates an exemplary exploded view of the cooking pot of FIGS. 1A and 1B, in accordance with embodiments of the present disclosure.

FIGS. 3A and 3B illustrate exemplary perspective views of a second embodiment of the proposed cooking pot, respectively showing a detachable lid of the cooking pot in open and closed positions, in accordance with embodiments of the present disclosure.

FIG. 4A illustrates an exemplary perspective view of the cooking pot of FIGS. 3A and 3B, showing internal details of the cooking pot, in accordance with embodiments of the present disclosure.

FIG. 4B illustrates an exemplary exploded view of the cooking pot of FIGS. 3A and 3B, in accordance with embodiments of the present disclosure.

FIGS. 5A and 5B illustrate exemplary perspective views of the proposed cooking pot configured for frying of food items, respectively showing the cooking pot with the hinged lid in open and closed positions, in accordance with embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various terms as used herein. To the extent a term used in a claim is not defined below, it should be given the broadest definition persons in the pertinent art have given that term as reflected in printed publications and issued patents at the time of filing.

Embodiments explained herein relate to a cooking pot that can be configured for pressure cooking or frying using microwaves as a source of heat. In addition, the cooking pot also includes other heating means, such as any of a hot plate, an electric heating coil and a flame stove. The at least one of a hot plate, an electric heating coil and a flame stove may be located below a pan of the cooking pot to provide a direct heating to the pan, and a microwaves generating device, to provide microwaves, may be located remote from the pan. The cooking pot can include a microwave guide to direct the microwaves from the microwaves generating device to the pan.

In an embodiment, the pan is accommodated in a housing of the cooking pot such that the pan is accessible from a top side of the housing, and a lid of the cooking pot closes over the top side of the housing such that an enclosure is created above an open end of the pan. The housing of the cooking pot includes a window located in the enclosure that allows the microwaves from the microwave guide to enter the enclosure and enable heating of contents of the pan.

In an embodiment, the proposed cooking pot can be configured for pressure cooking by configuring the lid to create an airtight enclosure above the pan. In which case, the window can include a microwave transparent material that is capable of withstanding pressure in the airtight enclosure during the pressure cooking.

In an alternate embodiment, the proposed cooking pot can be configured for frying. In which case the pan can be configured to hold oil, and the oil can be heated by any or a combination of the remotely located microwave generating device and the other heat source located below the pan.

In an embodiment, the cooking pot also includes a sensing mechanism to sense proper closing of the lid to ensure that microwaves reaching the enclosure do not leak out. The sensing mechanism includes a plurality of retractable plungers, such as pogo pins, provided on inner side walls of the housing such that when the lid is closed, the plungers come in contact with the lid to detect if a gap between the lid and the side walls of the enclosure is less than a predefined gap value.

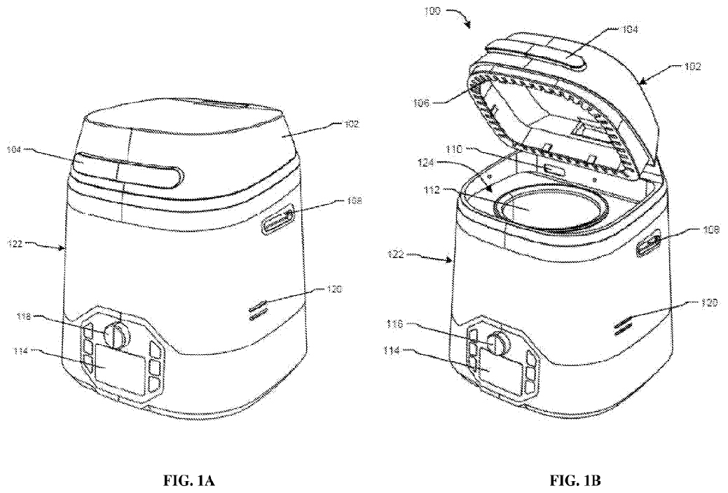

Referring now to FIGs. 1A and 1B, where an exemplary representations of one embodiment of the disclosed cooking pot having a hinged lid is disclosed. As shown therein, the cooking pot 100 can include a housing 122 and a lid 102. The lid 102 may be hinged to the housing 122 such that it can move between a closed position, shown in FIG. 1A, and an open position shown in FIG. 1B. The lid can include a lid lifting handle 104 located on a front surface of the lid 102 to facilitate opening and closing of the lid 102.

As shown in FIG. 1B, the cooking pot for pressure cooking 100 includes a pan 112 located within the housing 122 such that its open upper end is accessible from a top side of the housing 122. The pan 122 can be configured to hold food items to be pressure cooked. The top side of the housing 122 can be configured such that when the lid 102 is closed over the housing 122, an enclosure 124 is created that includes interiors of the pan 112.

The housing 122 further includes a user interface comprising a control display 114 and one or more knobs 118 located on a front side of the housing 122, one or more ventilation slits 120 located on sides of the housing 122 and a pair of lifting grips 108 located on opposite sides of the housing 122.

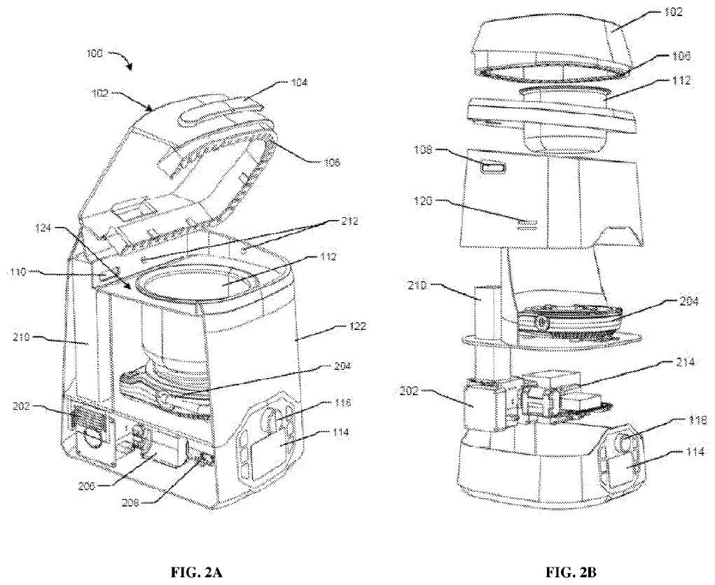

As shown in FIG. 1B, the cooking pot 100 can include a window 110 located in the housing 124. The window 110 can provide a passage for the microwaves from the microwave guide 210 (refer to FIGS. 2A and 2B) to the enclosure 124 above the pan 112 for the microwaves to heat the food items held in the pan 112. The lid can include a choke 106 located around a circumference of the lid 102 that engages with the housing 122 when the lid 102 is closed over the housing 122. The choke 106 may be configured to prevent leakage of microwaves from the enclosure 124.

Referring to FIGS. 2A and 2B, the housing 122 accommodates one or more heating devices to heat the pan 112. In an aspect, one of the one or more heating devices can be a microwaves generating device 202 located remote from the enclosure 124. In another aspect, the cooking pan 100 includes a microwave guide 210 to transfer microwaves generated by the remotely located microwaves generating device 202 to the enclosure 124. The housing also includes capacitor 206, transformer 214 and PCB 208 related to the microwaves generating device 202.

The one or more heating devices can also include at least one of a hot plate, an electric heating coil and a flame stove, wherein the at least one of a hot plate, an electric heating coil and a flame stove is located below the pan 112 to provide a direct heating to the pan 112. In the exemplary embodiment shown in FIGS. 2A and 2B is a flame stove 204. There can be suitable arrangement to provide supply of gas, or any other fuel, to the flame stove 204. Air for combustion of the fuel can enter the housing 122 through the ventilation slits 120.

The cooking pot 100 can also include a sensing mechanism to sense proper closing of the lid 102 to ensure that microwaves reaching the enclosure 124 do not leak out. The sensing mechanism can be based on a plurality of retractable plungers, such as pogo pins 212, provided on inner side walls of the housing such that when the lid 102 is closed, the pogo pins 212 come in contact with the lid 102 to detect if a gap between the lid 102 and the side walls of the housing 122 is less than a predefined gap value. The predefined gap value can relate to maximum gap allowed between the lid 102 and the inner sides of the housing 122 for efficient functioning of the choke 106.

The pogo pins 212 can be biased outward and configured to linearly move inward on coming in contact with the lid 102 as the lid is closed over the housing 122. The pogo pins 212 can be electrically connected such that the connection is completed when the pogo pins 212 make contact with the lid 102, and wherein the completion of the connection is used as a confirmation that the lid is properly closed over the housing 122.

In an embodiment, the cooking pot 100 can include a control circuit configured to switch the microwave generating device 202 ON only after the connection of all the pogo pins 212 is completed.

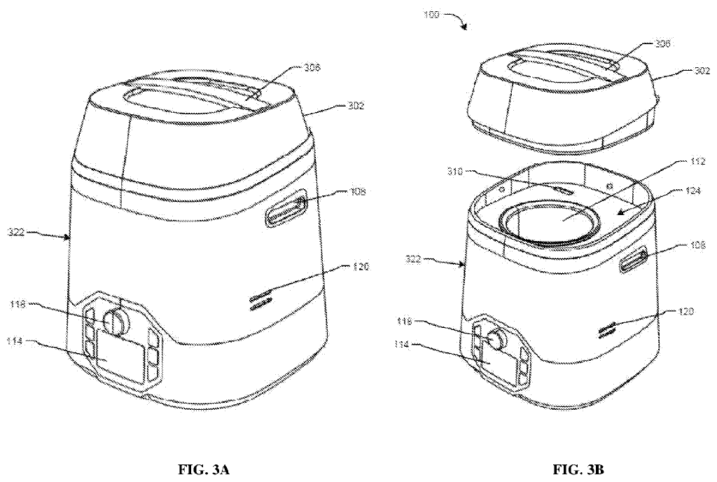

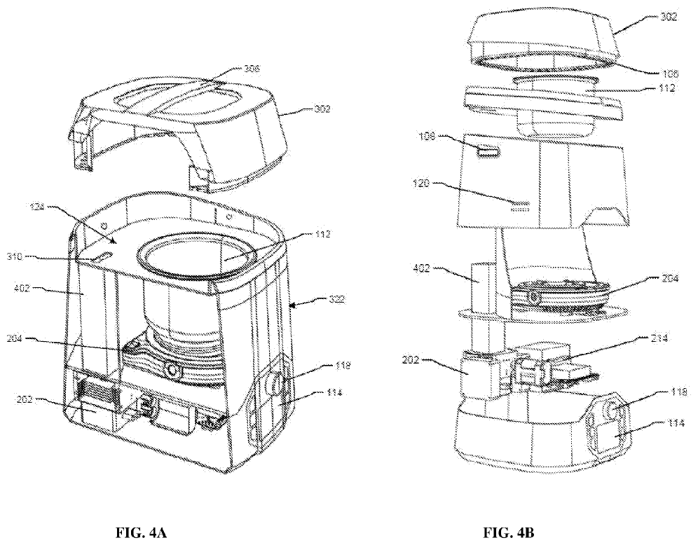

Referring to FIGS. 3A to 4B, in an alternate embodiment, the cooking pot 100 can have a detachable lid, such as lid 302, configured to be totally removed from a housing 322 of the cooking pot 100 in an open position of the lid 302, as shown in FIG. 3B. The lid 302 can include a lid handle 306 located on a top surface of the lid 302, and the choke 106 located around a circumference of the lid 302. Other features, such as lifting grips 108, pan 112, lifting grips 108, the user interface having the control display 114 and the one or more knobs 118, the enclosure 124, the flame stove 204, the microwaves generating device 202, the capacitor 206, the transformer 214 and the PCB 208 can be same as in the earlier embodiment. In keeping with changed configuration of the lid 302, the window location can be modified, such as shown as window 310 in FIGS. 3B and 4A. Correspondingly, the microwave guide can also be modified, such as shown as microwave guide 402 in FIGS. 4A and 4B.

In an embodiment, the disclosed cooking pot 100 can be configured for pressure cooking. To enable pressure cooking, the lid 102/302 and the housing 122/322 can be configured such that, when the lid 102/322 is closed, the created enclosure 124 is an airtight enclosure to prevent leakage and withstand pressure when pressure cooking is undertaken. The pan 112 may be fitted with the housing 122 in an appropriate manner, such as with gaskets and locking means. The window 110/310 can include a microwave transparent material that is capable of withstanding pressure in the enclosure 124 during the pressure cooking.

In an alternate embodiment, the disclosed cooking pot can be configured for frying of food items. For which, the pan may be configured to hold frying oil and the food items to be fried may be dipped in the oil.

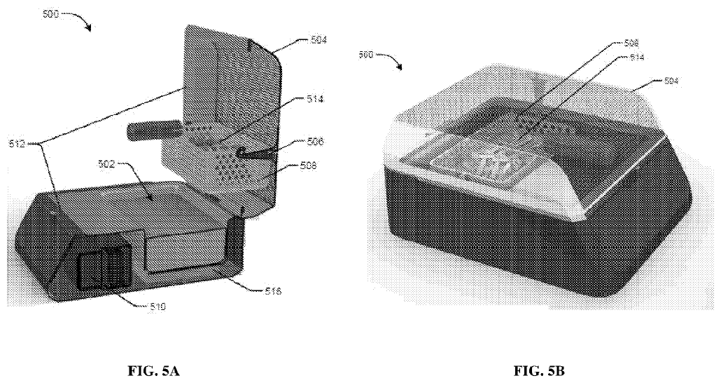

FIGS. 5A and 5B illustrate exemplary perspective views of the proposed cooking pot configured for frying of food items, respectively showing the cooking pot with the hinged lid in open and closed positions. As shown, the proposed cooking pot 500 configured for frying can include a pan 502 configured to hold oil, and a lid 504, which in a closed position covers the pan 502 and creates an enclosure above the pan 502. The lid 504 can include a pair of arms 506 fixed to the lid 504 and configured to hold a strainer 508 for holding food items 514 to be fried. The strainer 508, when placed on the arms 506, can have freedom to pivotally move so that when the lid 502 is moved to closed position, the strainer 508 remains in horizontal orientation and gets dipped in the oil in the pan 502. A microwave generating device 510 can be located remote from the pan 502 to generate microwaves. The microwaves can be transferred to the enclosure above the pan via a microwave guide (not shown here), such as microwave guide 210/402 shown in FIGS. 2A, 2B, 4A and 4B. Another heat source 516, such as any of a hot plate, an electric heating coil and a flame stove may be provided under the pan 502 for direct heating. The lid 504 and the housing can include choke 512 to prevent leakage of the microwaves from the enclosure, when the lid 504 is closed.

Thus the present disclosure provides an improved cooking pot that overcomes drawbacks of known cooking apparatuses that use multiple sources of heat energy including microwaves, and can be configured for pressure cooking or frying.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides an improved cooking pot that overcomes drawbacks of known cooking apparatuses that use multiple sources of heat energy including microwaves.

The present disclosure provides a cooking pot that can be configured for pressure cooking or frying.

The present disclosure provides a cooking pot that ensures proper alignment of a pan with lid of the cooking pot.

The present disclosure provides a cooking pot that does not allow a microwaves generating device to be switched on unless the lid is properly placed over the pan.

The present disclosure provides a cooking pot that ensures that the microwaves generating device is unaffected by pressure of a pressurized pan.

I claim:

1. A cooking pot for cooking, the cooking pot comprising:
a housing accommodating a pan that is accessible from a top side of the housing, the pan being configured to hold food items to be cooked, the housing further accommodating one or more heating devices to heat the pan; and
a lid configured to cover the top side of the housing in a closed position of the lid, wherein the lid is configured to create, in the closed position of the lid, an enclosure above the pan to enable cooking of contents of the pan;
wherein the one or more heating devices include a microwaves generating device located remote from the airtight enclosure; and
wherein the cooking pan includes a microwave guide to transfer microwaves generated by the remotely located microwaves generating device to the enclosure.

2. The cooking pot as claimed in claim 1, wherein the cooking pot includes a window located in the housing, the window providing a passage for the microwaves from the microwave guide to the enclosure above the pan for the microwaves to heat the food items held in the pan.

3. The cooking pot as claimed in claim 2, wherein the lid is configured such that the enclosure created in the closed position of the lid is an air tight enclosure to enable pressure cooking of contents of the pan, and wherein the window includes a microwave transparent material, the microwave transparent material being capable of withstanding pressure in the airtight enclosure during the pressure cooking.

4. The cooking pot as claimed in claim 1, wherein the pan is configured to hold oil for frying the food items.

5. The cooking pot as claimed in claim 1, wherein the lid is hinged to the housing for a pivotal movement between an open position and the closed position.

6. The cooking pot as claimed in claim 2, wherein the lid includes a lid lifting handle located on a front surface of the lid.

7. The cooking pot as claimed in claim 1, wherein the lid is a detachable lid configured to be totally removed from the housing in an open position of the lid.

8. The cooking pot as claimed in claim 3, wherein the lid includes a lid handle located on a top surface of the lid.

9. The cooking pot as claimed in claim 1, wherein the lid includes a choke located around a circumference of the lid that engages with the housing in the closed position of the lid, the choke being configured to prevent leakage of microwaves from the airtight enclosure.

10. The cooking pot as claimed in claim 1, wherein the one or more heating devices include at least one of a hot plate, an electric heating coil and a flame stove, wherein the at least one of a hot plate, an electric heating coil and a flame stove is located below the pan to provide a direct heating to the pan.

11. The cooking pot as claimed in claim 1, wherein the cooking pot includes a sensing mechanism to sense proper closing of the lid to ensure that microwaves reaching the airtight enclosure do not leak out.

12. The cooking pot as claimed in claim 10, wherein the sensing mechanism comprises a plurality of retractable plungers provided on inner side walls of the housing such that when the lid is closed, the plungers come in contact with the lid to detect if a gap between the lid and the side walls of the airtight enclosure is less than a predefined gap value.
